(19) United States
(12) Patent Application Publication
(10) Pub. No.: US 2024/0079908 A1
(43) Pub. Date: Mar. 7, 2024

(54) ELECTRONIC DEVICE

(71) Applicant: SAMSUNG ELECTRONICS CO., LTD., Suwon-si (KR)

(72) Inventors: Jaelim KIM, Suwon-si (KR); Jiwoo LEE, Suwon-si (KR)

(73) Assignee: SAMSUNG ELECTRONICS CO., LTD., Suwon-si (KR)

(21) Appl. No.: 18/389,109

(22) Filed: Nov. 13, 2023

Related U.S. Application Data
(63) Continuation of application No. PCT/KR2023/009039, filed on Jun. 28, 2023.

(30) Foreign Application Priority Data
Jul. 28, 2022 (KR) 10-2022-0093988
Sep. 8, 2022 (KR) 10-2022-0114512

(51) Int. Cl. H02J 50/12; G06F 3/0346; G06F 3/0354; G06F 3/041

(52) U.S. Cl. CPC H02J 50/12; G06F 3/0346; G06F 3/03545; G06F 3/04162; G06F 2200/1632

(57) ABSTRACT

An electronic device, including a communication module configured to communicate with a pen input device which is attachable to the electronic device; a tilt sensor configured to sense information about a tilt of the electronic device; a memory configured to store instructions; and at least one processor operatively connected to the communication module, and configured to execute the instructions to: determine an attachment state of the pen input device with respect to the electronic device based on a wireless charging state of the pen input device, a tilt sensing value of the pen input device, and a tilt sensing value of the electronic device; and based on the attachment state, control a wireless charging current for charging the pen input device, and selectively display an attachment guide of the pen input device

### CROSS-REFERENCE TO RELATED APPLICATIONS

This application is a continuation application of International Application No. PCT/KR2023/009039 designating the United States, filed on Jun. 28, 2023, in the Korean Intellectual Property Receiving Office and claiming priority to Korean Patent Application No. 10-2022-0093988, filed on Jul. 28, 2022, and Korean Patent Application No. 10-2022-0114512, filed on Sep. 8, 2022, in the Korean Intellectual Property Office, the disclosures of which are incorporated by reference herein in their entireties.

### BACKGROUND

### 1. Field

The disclosure relates to an electronic device for wirelessly charging a pen input device.

### 2. Description of Related Art

An input device such as a pen input device may be used with portable electronic devices, such as smartphones or tablet personal computers (PCs). For example, smartphones or tablet PCs may be equipped with a touch screen, and a user may designate specific coordinates of the touch screen using a finger or a pen input device. The user may input a specific signal to a smartphone by designating specific coordinates of the touch screen.

### SUMMARY

Provided is an electronic device for wirelessly charging a pen input device.

Additional aspects will be set forth in part in the description which follows and, in part, will be apparent from the description, or may be learned by practice of the presented embodiments.

In accordance with an aspect of the disclosure, an electronic device includes a communication module configured to communicate with a pen input device which is attachable to the electronic device; a tilt sensor configured to sense information about a tilt of the electronic device; a memory configured to store instructions; and at least one processor operatively connected to the communication module, and configured to execute the instructions to: determine an attachment state of the pen input device with respect to the electronic device based on a wireless charging state of the pen input device, a tilt sensing value of the pen input device, and a tilt sensing value of the electronic device; and based on the attachment state, control a wireless charging current for charging the pen input device, and selectively display an attachment guide of the pen input device.

In accordance with an aspect of the disclosure, an electronic device includes a housing having an internal space configured to accommodate one or more electronic components; a wireless charging coil positioned inside the housing, and configured to charge a pen input device which is attachable to the electronic device; a pen attachment magnet aligned in a same direction as the wireless charging coil inside the housing, and configured to cause the pen input device to attach to a surface of the electronic device; a tilt sensor configured to sense information about a tilt of the electronic device; a communication module configured to receive information about a tilt of the pen input device; and at least one processor configured to control a wireless charging current for charging the pen input device, and to selectively display an attachment guide of the pen input device, based on first tilt sensing values sensed by the electronic device and second tilt sensing values sensed by the pen input device based on the electronic device being synchronized with the pen input device.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an embodiment;

FIG. 2 is a front perspective view of an electronic device according to an embodiment;

FIG. 3 is a rear perspective view of the electronic device of FIG. 2 according to an embodiment;

FIG. 4 is an exploded perspective view of an electronic device according to an embodiment;

FIG. 5 is a diagram illustrating an electronic device and a pen input device aligned on a surface of the electronic device, according to an embodiment;

FIG. 6 is a diagram illustrating a view in which a pen input device attaches to an electronic device in a forward direction, according to an embodiment;

FIG. 7 is a diagram illustrating an internal configuration of a pen input device attaching to a side member and an internal configuration of an electronic device corresponding to the pen input device, according to an embodiment;

FIG. 8 is a diagram illustrating a wireless charging operation of an electronic device and a pen input device, according to an embodiment;

FIG. 9 is a diagram illustrating a calibration operation of an electronic device and a pen input device, according to an embodiment;

FIGS. 10A and 10B are diagrams illustrating attachment states of a pen input device with respect to an electronic device, according to an embodiment;

FIG. 11 illustrates examples of relative angles of a pen input device with respect to an electronic device, according to an embodiment; and

FIG. 12 illustrates an example of an attachment guide of a pen input device, which is displayed on an electronic device, in response to an attachment state of the pen input device, according to an embodiment.

### DETAILED DESCRIPTION

Hereinafter, embodiments will be described in detail with reference to the accompanying drawings. When describing the embodiments with reference to the accompanying drawings, like reference numerals refer to like elements and a redundant or duplicative description related thereto may be omitted.

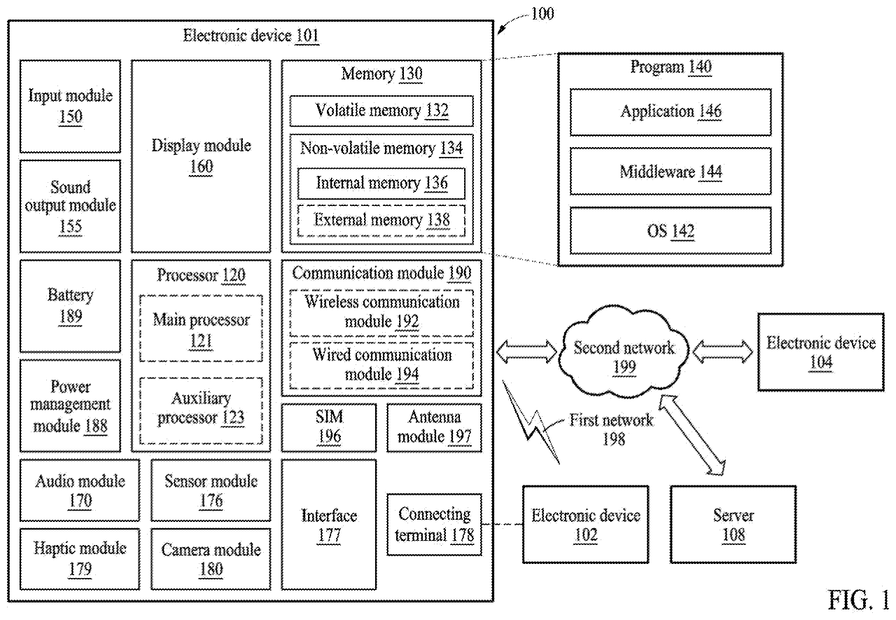

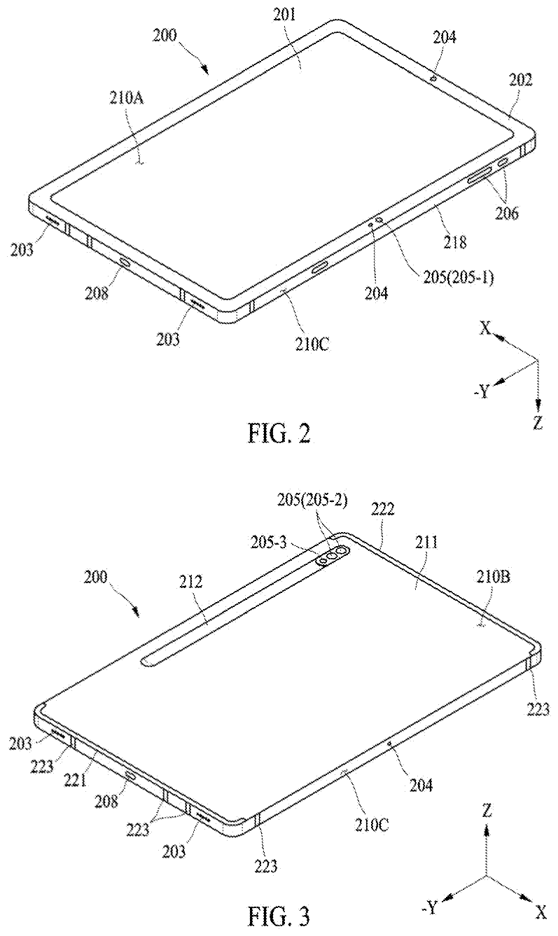

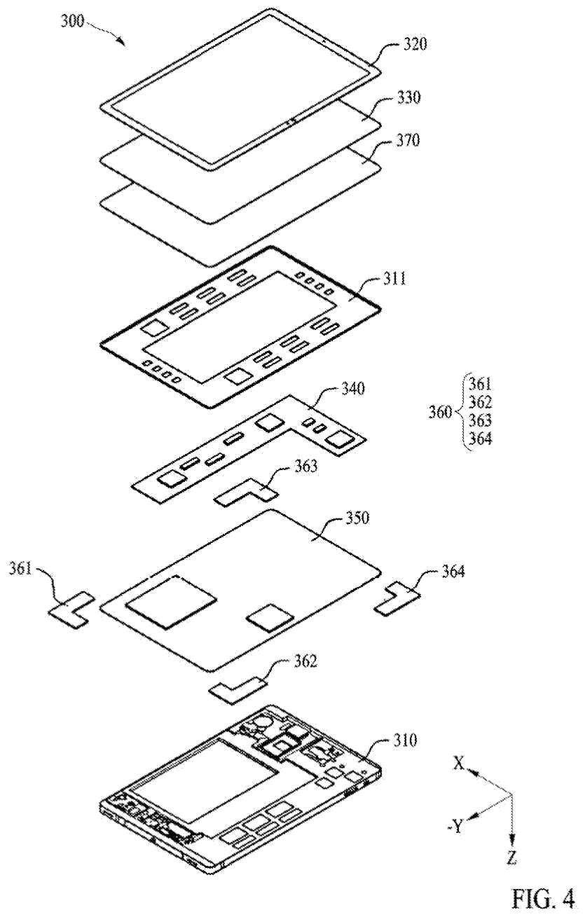

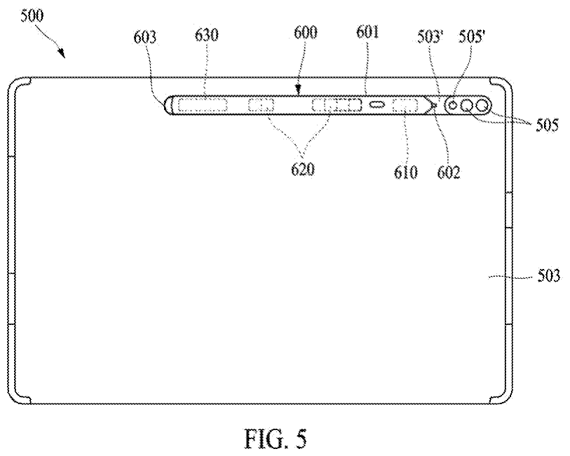

FIG. 1 is a block diagram illustrating an electronic device 101 (e.g., an electronic device 200 of FIG. 2, an electronic device 300 of FIG. 4, and an electronic device 500 of FIG. 5) in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170 (e.g., an audio module 203 of FIG. 2), a sensor module 176 (e.g., a sensor module 204 of FIG. 2), an interface 177, a connecting terminal 178, a haptic module 179, a camera module 180 (e.g., a cameral module 205 of FIG. 2), a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

According to an embodiment, the processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be predetermined to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an image signal processor (ISP) or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but embodiments are not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146. \

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may sense an operational state (e.g., power or temperature) of the electronic device 101 or an environmental state (e.g., a state of a user) external to the electronic device 101, and generate an electrical signal or a data value corresponding to the sensed state. According to an embodiment, the sensor module 176 may include, for example, a gesture sensor, a gyro sensor (or gyroscopic sensor), an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or movement) or an electrical stimulus which may be recognized by a user via his or her tactile sensation or kinesthetic sensation. According to an embodiment, the haptic module 179 may include, for example, a motor, a piezoelectric element, or an electric stimulator.

According to an embodiment, the camera module 180 may capture still images and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

In an embodiment, the battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

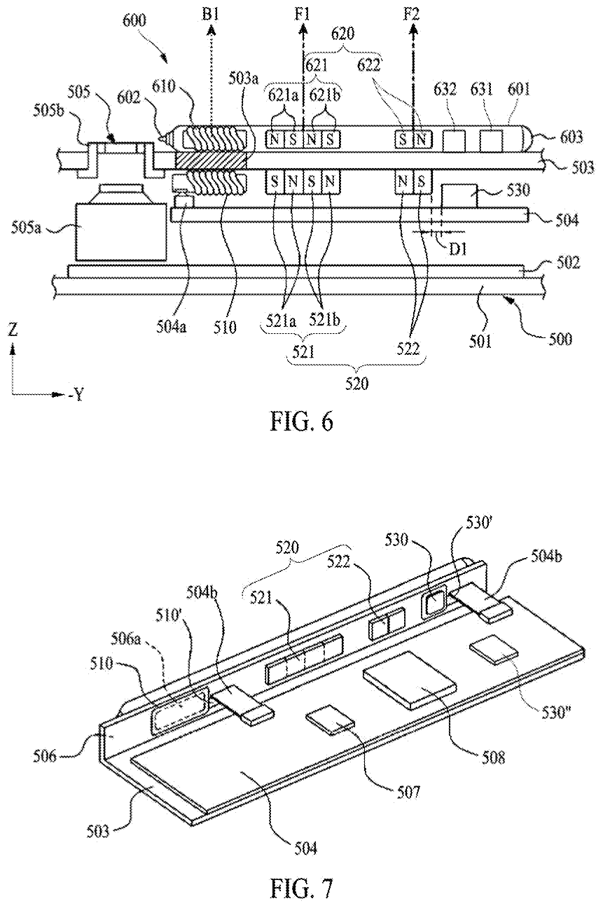

According to an embodiment, the antenna module 197 may form a mmWave antenna module. According to an embodiment, the mmWave antenna module may include a PCB (e.g., a PCB 340 of FIG. 4 and a PCB 504 of FIGS. 6 and 7), an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band. At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In addition, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 2 is a front perspective view of an electronic device 200 according to an embodiment. FIG. 3 is a rear perspective view of the electronic device 200 of FIG. 2.

FIGS. 2 and 3 illustrate a spatial coordinate system defined by an X-axis, a Y-axis, and a Z-axis that are orthogonal to each other. Here, the X-axis may represent the width direction of an electronic device 200, the Y-axis may represent the length direction of the electronic device 200, and the Z-axis may represent the height direction of the electronic device 200. In embodiments, the −Y direction illustrated in FIG. 2 may be a direction along the Y-axis that is opposite to a Y direction (or a +Y direction) along the Y-axis.

Referring to FIGS. 2 and 3, the electronic device 200 according to an embodiment may include a housing 210 including a first surface 210A, which may be for example a front surface, a second surface 210B, which may be for example a front surface, and a side surface 210C enclosing a space between the first surface 210A and the second surface 210B. The housing 210 may also refer to a structure which forms a portion of the first surface 210A, the second surface 210B, and the side surface 210C of FIG. 2. In an embodiment, the first surface 210A may include a first plate 202 (e.g., a first plate 320 of FIG. 4 and a first plate 501 of FIG. 6), which may be for example a polymer plate or a glass plate including various coating layers, and of which at least a portion is substantially transparent. The second surface 210B may include a second plate 211 (e.g., a second plate 503 of FIG. 5 to FIG. 7) that is substantially opaque. The second plate 211 may include, for example, one of coated or colored glass, ceramic, polymer, metal (e.g., aluminum, stainless steel (STS), or magnesium), or a combination of at least two thereof. For example, the second plate 211 may include a combination of metal and glass. Here, the glass may include a plurality of glass combinations of different colors, materials, and/or textures. The side surface 210C may couple to the first plate 202 and the second plate 211 and may include a side member 218 (e.g., a side bezel structure 310 of FIG. 4 and a side member 506 of FIG. 6) including metal and/or polymer. The second plate 211 and the side member 218 may be integrally formed and may include the same material (e.g., a metal material, such as aluminum).

According to an embodiment, the electronic device 200 may include at least one of a display 201 (e.g., a display 330 of FIG. 4 and a display 502 of FIG. 6), an audio module 203 (e.g., the audio module 170 of FIG. 1), a sensor module 204 (e.g., the sensor module 176 of FIG. 1), a camera module 205 (e.g., the camera module 180 of FIG. 1), a key input device 206, and a connector hole 208. The electronic device 200 may omit at least one of the components (e.g., the key input device 206) or may additionally include other components. At least one of the components of the electronic device 200 may be the same as or similar to at least one of the components of the electronic device 101 of FIG. 1, and a redundant or duplicative description thereof may be omitted hereinafter.

According to an embodiment, the display 201 may be exposed through, for example, a portion of the first plate 202. The display 201 may have a rectangular outer shape. An edge of the display 201 may be substantially the same as an adjacent outer shape of the first plate 202. In order to expand the exposed area of the display 201, a distance between the edge of the display 201 and the edge of the first plate 202 may be substantially the same.

According to an embodiment, the display 201 may include a liquid crystal display (LCD), a light emitting diode (LED) display, an organic light emitting diode (OLED) display, a microelectromechanical system (MEMS) display, a flexible display, or an electronic paper display. The display 201 may display, for example, various types of content (e.g., text, an image, a video, an icon, a symbol, and the like) to a user.

In an embodiment, an opening may be formed in a portion of a screen display region of the display 201. The electronic device 200 may include at least one of the audio module 203, the sensor module 204, and the camera module 205 that are aligned with the opening. The display 201 may couple to or be adjacent to a pressure sensor for measuring an intensity (pressure) of a touch and/or a digitizer for recognizing coordinates of a magnetic-type pen input. The display 201 may receive, for example, a touch input, a gesture input, a proximity input, or a hovering input using a pen input device (e.g., a pen input device 600 of FIG. 5), which may be for example a stylus pen, or a part of a user's body.

According to an embodiment, the audio module 203 may include a microphone hole and a speaker hole. A microphone for obtaining external sound may be in the microphone hole. The microphone hole may include a plurality of microphones at different positions (or on different surfaces) of an electronic device in order to sense a direction of sound. The speaker hole may include an external speaker hole and/or a receiver hole for a call. The microphone hole may be implemented as a single hole with the speaker hole, or include a speaker (e.g., a piezo speaker) without the speaker hole.

According to an embodiment, the sensor module 204 may generate an electrical signal or a data value corresponding to an internal operating state of the electronic device 200 or an external environmental state. The sensor module 204 may be, for example, on the first surface 210A of the housing 210 or the second surface 210B of the housing 210 and may be additionally or alternatively on the side surface 210C. The sensor module 204 may further include at least one of a proximity sensor, an illuminance sensor, a biometric sensor, a gesture sensor, a gyro sensor, an atmospheric pressure sensor, a magnetic sensor, an acceleration sensor, a grip sensor, a color sensor, an infrared (IR) sensor, a temperature sensor, or a humidity sensor.

According to an embodiment, the camera module 205 may include a first camera device 205-1 on the first surface 210A of the electronic device 200, a second camera device 205-2 on the second surface 210B, and/or a flash 205-3. The first camera device 205-1 and the second camera device 205-2 may each include one or more lenses, an image sensor, and/or an image signal processor (ISP). The flash 205-3 may include, for example, an LED or a xenon lamp. Two or more lenses (IR cameras, wide angle and telephoto lenses) and image sensors may be on one surface of the electronic device 200.

According to an embodiment, the key input device 206 may be on the side surface 210C of the housing 210. In addition, the electronic device 200 may not include some or all of the key input device 206 described above. The key input device 206 that is not included in the electronic device 200 may be implemented in another form, such as a soft key, on the display 201.

According to an embodiment, the connector hole 208 may include a connector hole for accommodating a connector (e.g., a universal serial bus (USB) connector) for transmitting and receiving power and/or data to and from an external electronic device and/or may include a connector hole for accommodating a connector (e.g., an earphone jack) for transmitting and receiving audio signals to and from an external electronic device.

FIG. 4 is an exploded perspective view of an electronic device according to an embodiment.

Referring to FIG. 4, according to an embodiment, an electronic device 300 (e.g., the electronic device 101 of FIG. 1, the electronic device 200 of FIG. 2, and/or an electronic device 500 of FIG. 5) may include a side bezel structure 310 (e.g., the side member 218 of FIG. 2 and/or a side member 506 of FIG. 6), a first support member 311 (e.g., a bracket), a first plate 320 (e.g., the first plate 202 of FIG. 2 and/or a first plate 501 of FIG. 6), a display 330 (e.g., the display 201 of FIG. 2 and/or a display 502 of FIG. 6), an electromagnetic induction panel 370, a PCB 340 (e.g., a PCB 504 of FIGS. 6 and 7), and a battery 350 (e.g., the battery 189 of FIG. 1). A second plate (e.g., the second plate 211 of FIG. 3 and/or a second plate 503 of FIGS. 5 to 7) that faces the opposite direction to the first plate 320 may be integrally formed with the side bezel structure 310 (e.g., the side member 218 of FIG. 2 and/or a side member 506 of FIG. 6). The electronic device 300 may omit at least one of the components (e.g., the first support member 311) or additionally include other components. At least one of the components of the electronic device 300 may be the same as or similar to at least one of the components of the electronic device 200 of FIG. 2 or an electronic device 500 of FIG. 5. Therefore, redundant or duplicative description thereof may be omitted.

According to an embodiment, the electromagnetic induction panel 370 (e.g., a digitizer) may be a panel for sensing an input of a pen input device (e.g., a pen input device 600 of FIG. 5). For example, the electromagnetic induction panel 370 may include a PCB (e.g., a flexible PCB (FPCB)) and a shielding sheet. The shielding sheet may prevent the components (e.g., a display module, a PCB, an electromagnetic induction panel, and the like) in the electronic device 300 from mutual interference caused by an electromagnetic field generated by the components. The shielding sheet may block the electromagnetic field generated by the components in order to accurately transmit an input from the pen input device 600 to a coil included in the electromagnetic induction panel 370.

The first support member 311 may be inside the electronic device 300 and connect to the side bezel structure 310 or may be formed integrally with the side bezel structure 310. The first support member 311 may include, for example, a metal material and/or a non-metal material (e.g., polymer). The display 330 may connect to one surface of the first support member 311, and the PCB 340 may connect to another surface of the first support member 311. A processor (e.g., the processor 120 of FIG. 1 or a processor 508 of FIG. 7), a memory (e.g., the memory 130 of FIG. 1), and/or an interface (e.g., the interface 177 of FIG. 1) may be mounted on the PCB 340. The processor may include, for example, at least one of a CPU, an AP, a GPU, an ISP, a sensor hub processor, or a CP.

In an embodiment, the memory may include, for example, a volatile memory or a non-volatile memory.

According to an embodiment, the interface may include, for example, an HDMI interface, a USB interface, a secure digital (SD) card interface, and/or an audio interface. For example, the interface may electrically or physically connect the electronic device 300 to an external electronic device and may include a USB connector, an SD card/multimedia card (MMC) connector, or an audio connector.

In an embodiment, the battery 350, which is a device for supplying power to at least one component of the electronic device 300, may include, for example, a primary cell that is not rechargeable, a secondary cell that is rechargeable, or a fuel cell. For example, at least a portion of the battery 350 may be on substantially the same plane as the PCB 340. The battery 350 may be integrally located inside the electronic device 300 or may be detachable from the electronic device 300.

According to an embodiment, the electronic device 300 may further include antennas 361, 362, 363, and 364. Referring to FIGS. 3 and 4, at least a portion of a housing (e.g., the housing 210 of FIGS. 2 and 3) of the electronic device 300 may be used as a radiator of the antennas 361, 362, 363, and 364. For example, at least a portion of a frame of the housing 210 may be used as a radiator of an antenna (hereinafter, referred to as a ‘frame antenna’). The frame antenna may be distinguished from another adjacent frame antenna through a band-shaped antenna ejection member and a plurality of slits. According to an embodiment, a 5G mmWave antenna may be accommodated inside the housing 210 of the electronic device 300. For example, short-range communication with an external device may be performed or charging power may be wirelessly transmitted or received by using an antenna.

FIG. 5 is a diagram illustrating an electronic device and a pen input device aligned on a surface of the electronic device, according to an embodiment.

Referring to FIG. 5, according to an embodiment, a pen input device 600 (e.g., a stylus pen) may attach to one surface of a housing (e.g., the housing 210 of FIGS. 2 and 3) of an electronic device 500 (e.g., the electronic device 101 of FIG. 1, the electronic device 200 of FIGS. 2 and 3, and/or the electronic device 300 of FIG. 4). According to an embodiment, as shown in FIG. 5, the pen input device 600 may attach to a portion of a second plate 503 (e.g., the second plate 211 of FIG. 3), which may be for example a rear plate, of the housing. In addition, as described below with reference to FIG. 7, the pen input device 600 may attach to a portion of a side member (e.g., the side member 218 of FIG. 2) of the housing. The pen input device 600 may attach to one surface of a protective case that protects the housing 210 of the electronic device 500. An attachment guide region 503′ may be provided on one surface of the housing. The attachment guide region 503′ may be an indication area which indicates an attaching position of the pen input device 600. A groove corresponding to the attachment guide region 503′ may be provided in a protective case that protects the housing 210 of the electronic device 500. The pen input device 600 may attach to a groove (e.g., the groove corresponding to the attachment guide region 503′) in the protective case. According to an embodiment, a guide groove may be formed to indicate the attaching position of the pen input device 600. In addition, the attachment guide region 503′ may include a different material from other parts of the housing (e.g., a housing made of a metallic material and an attachment guide region made of a non-conductive material, such as glass) in order to indicate the attaching position. The attachment guide region 503′ may have a different color from other parts of the housing in order to indicate the attaching position. At least one of the components of the electronic device 500 may be the same as or similar to at least one of the components of the electronic device 200 of FIG. 2 or the electronic device 300 of FIG. 4. Therefore, redundant or duplicative description thereof may be omitted here.

In embodiments corresponding to FIG. 5, the attachment guide region 503′ may be adjacent to a camera module 505 (e.g., the second camera module 205-2 of FIG. 3) of the second plate 503. According to an embodiment, the attachment guide region 503′ may have a shape extending in one direction from an area where the camera module 505 is formed. For example, the attachment guide region 503′ may extend from an enclosure of the camera module 505 in a longitudinal direction (e.g., −Y direction in FIG. 2) of the electronic device 500.

According to an embodiment, a pen housing 601 of the pen input device 600 may have an elongated body and include a first end 602 and a second end 603 that are opposite to each other with the elongated body therebetween. Here, the first end 602 may have a shape narrowing in width towards the end. The first end 602 may include a pen tip for implementing an input (e.g., writing) to the electronic device 500 by a user applying pressure to a display (e.g., the display 201 of FIG. 2, the display 330 of FIG. 4, and/or the display 502 of FIG. 6). The inside of the pen housing 601 may include an inner space surrounded by the body, the first end 602, and the second end 603. According to an embodiment, at least a portion of the pen housing 601 (e.g., the body) may be made of a synthetic resin (e.g., plastic) material. Another portion of the pen housing 601 may be made of, for example, a metallic material (e.g., aluminum or stainless steel (SUS)).

According to an embodiment, the pen input device 600 may include a coil 610, at least one magnetic body 620, a battery 630, a tilt sensor (e.g., a tilt sensor 631 of FIG. 6), and a communication module (e.g., a communication module 632 of FIG. 6). The tilt sensor 631 may sense information about the tilt of the pen input device 600. The communication module 632 may transmit the information sensed by the tilt sensor 631 to the electronic device 500.

According to an embodiment, the pen input device 600 may be operatively interlocked or coupled with an electromagnetic induction panel (e.g., the electromagnetic induction panel 370 of FIG. 4), which may be for example a digitizer, by using the coil 610 through an electro-magnetic resonance (EMR) method, an active electrical stylus (AES) method, and an electric coupled resonance (ECR) method. In addition, the coil 610 may be interlocked or coupled with a wireless charging coil (e.g., a wireless charging coil 510 of FIG. 6) included in the electronic device 500. The coil 610 may be coupled to a wireless charging coil (e.g., the wireless charging coil 510 of FIG. 6) included in the electronic device 500 and thus wirelessly charge the battery 630. According to an embodiment, resonance with an electromagnetic induction panel (e.g., the electromagnetic induction panel 370 of FIG. 4) and wireless charging of the battery 630 may be performed by the coil 610 of one included in the pen input device 600.

According to an embodiment, the pen input device 600 may attach to the outside of the housing of the electronic device 500, for example, to the attachment guide region 503′. The pen input device 600 may overlap the attachment guide region 503′ in the same longitudinal direction as the attachment guide region 503′. The inside of the pen housing 601 may include the at least one magnetic body (e.g., at least one magnetic body included in second magnetic body group 620) for facilitating the attachment of the pen housing 601 to the attachment guide region 503′. The at least one magnetic body 620 may be at a position corresponding to at least one magnetic body (e.g., at least one magnetic body included in first magnetic body group 520 of FIG. 6 described below) in the electronic device 500, thereby overlapping the magnetic body in the electronic device 500. According to an embodiment, when the at least one magnetic body included in the pen input device 600 is at a position overlapping the at least one magnetic body of the electronic device 500, the pen input device 600 may attach to the attachment guide region 503′ by the action of attraction force and/or repulsion force between the magnetic bodies. The at least one magnetic body included in the pen input device 600 may accurately attach to the at least one magnetic body of the electronic device 500 at a designated position of the attachment guide region 503′ by the repulsive force between the same poles and the attraction force between different poles. In addition, when the at least one magnetic body included in the pen input device 600 is not at the position overlapping the at least one magnetic body of the electronic device 500, the pen input device 600 may not attach to the attachment guide region 503′ or may not properly be aligned therewith. According to an embodiment, when the pen input device 600 overlaps the attachment guide region 503′ in the longitudinal direction, forward attaching may refer to the case where the first end 602 accommodating a pen tip is adjacent to a position corresponding to the wireless charging coil 510 of the electronic device 500. In addition, when the pen input device 600 overlaps the attachment guide region 503′ in the longitudinal direction, reversed attaching may refer to the case where the second end 603 of the pen input device 600 is adjacent to a position corresponding to the wireless charging coil 510 of the electronic device 500. When the pen input device 600 attaches to the electronic device 500 in an opposite direction to the wireless charging coil 510 of the electronic device 500, a failure of normal wireless charging may cause the pen input device 600 to discharge, in which case, recharging of the pen input device 600 may need to be additionally performed to use the pen input device 600.

According to an embodiment, in addition to a pen input function using the pen input device 600, a function of a remote-control input device using short-range communication may be performed. For example, a communication module, an antenna, and the battery 630 may be included in the pen input device 600, so that the pen input device 600 may be used for an active function (e.g., Bluetooth communication or Bluetooth low energy communication) rather than as a simple writing instrument. The battery 630 in the pen input device 600 may not be limited to any particular battery. For example, a chip-type battery or a cylinder-type battery may be used as the battery 630. The position of the battery 630 in the pen input device 600 is not also not limited to any particular embodiment. The embodiment shown in FIG. 5 illustrates that the battery 630 is on the second end 603 of the pen input device 600. However, in another embodiment, the battery 630 may be between magnetic bodies 620. Hereinafter, configurations of the electronic device 500 and the pen input device 600, a wireless charging operation between the electronic device 500 and the pen input device 600, and a method of recognizing misalignment between the electronic device 500 and the pen input device 600 are described in detail with reference to FIGS. 6 and 7. For convenience of explanation, the at least one magnetic body included in the electronic device 500 may be referred to as a first magnetic body group 520. The at least one magnetic body included in the pen input device 600 may be referred to as a second magnetic body group 620.

FIG. 6 is a diagram illustrating a state in which a pen input device attaches to an electronic device in a forward direction, and FIG. 7 is a diagram illustrating the pen input device attaching to a side member and an internal configuration of the electronic device corresponding to the pen input device.

Referring to FIGS. 6 and 7, an electronic device 500 (e.g., the electronic device 101 of FIG. 1, the electronic device 200 of FIG. 2, or the electronic device 300 of FIG. 4) according to an embodiment may include a housing (e.g., the housing 210 of FIGS. 2 and 3), a wireless charging coil 510, a first magnetic body group 520 (e.g., a pen attachment magnet), tilt sensors 530 and 530″, and a PCB 504 (e.g., the PCB 340 of FIG. 4). The internal space of the housing may accommodate electronic components. The wireless charging coil 510 may be on an inner side surface of the housing forming an inner space. The first magnetic body group 520 may be on the inner side surface of the housing and be aligned with the wireless charging coil 510 in a first direction. The tilt sensor 530 may be at a predetermined distance from the first magnetic body group 520 and may sense the tilt value of the electronic device 500. Electronic components of the electronic device 500 may be on the PCB 504. Referring to FIG. 6, the tilt sensor 530 may be on the PCB 504. Referring to FIG. 7, the wireless charging coil 510, the first magnetic body group 520, and the tilt sensor 530 may attach to a side member 506 of the electronic device 500, and the electronic device 500 may further include the tilt sensor 530″. At least one of the components of the electronic device 500 may be the same as or similar to at least one of the components of the electronic device 101 of FIG. 1, the electronic device 200 of FIG. 2, or the electronic device 300 of FIG. 4, and redundant or duplicative description thereof may be omitted hereinafter.

According to an embodiment, a pen input device 600 may include a coil 610, a second magnetic body group 620, a battery (e.g., the battery 630 of FIG. 5), a tilt sensor 631, and a communication module 632. The tilt sensor 631 may sense information about the tilt of the pen input device 600. The communication module 632 may transmit the information sensed by the tilt sensor 631 to the electronic device 500.

According to an embodiment, the housing (e.g., the housing 210 of FIGS. 2 and 3) of the electronic device 500 may include a first plate 501 (e.g., the first plate 202 of FIG. 2 and the first plate 320 of FIG. 4), a second plate 503 (e.g., the second plate 211 of FIG. 3), and a side member (e.g., the side member 506 of FIG. 7) surrounding a space between the first plate 501 and the second plate 503. The first plate 501 may form the front surface of the electronic device 500 and may be substantially transparent, so that a display 502 (e.g., the display 201 in FIG. 2 or the display 330 of FIG. 4) may be exposed to the outside. The second plate 503 may be a part of the housing facing the opposite direction to the first plate 501 and may form the rear surface of the electronic device 500.

According to an embodiment, a plurality of electronic components may be in an inner space between the first plate 501 and the second plate 503. FIGS. 6 and 7 illustrate a camera module 505 (e.g., the camera module 205-2 of FIG. 3) equipped with an optical lens system 505a for obtaining visual information through an opening in an enclosure of the rear surface of the electronic device 500. The optical lens system 505a may include an image sensor and a lens assembly. In addition, various electronic components other than the camera module 505 may be in the inner space between the first plate 501 and the second plate 503. For example, the electronic components may include a charging circuit 507 and a processor 508 described below with reference to FIG. 7.

According to an embodiment, the pen input device 600 may attach to the outer surface of the second plate 503. Referring to FIG. 5, the attachment guide region 503′ may be included on the second plate 503, so that a user may easily recognize the attaching position of the pen input device 600 and attach the pen input device 600 thereto. According to an embodiment, the attachment guide region 503′ may include a different material from that of the second plate 503. For example, when the second plate 503 is made of a metal material, the attachment guide region 503′ may include glass. Correspondingly, the wireless charging coil 510 and the first magnetic body group 520 may be on the inner side surface of the second plate 503 among the inner surfaces forming the inner space of the housing of the electronic device 500.

According to an embodiment, the wireless charging coil 510 may be a component for wirelessly charging the battery 630 of the pen input device 600 and may be a coil for coupling to the coil 610 of the pen input device 600 and thus transmitting power. The wireless charging coil 510 may be electrically connected to a charging circuit (e.g., the charging circuit 507 of FIG. 7 described below) on the PCB 504 through a connector 504a on the PCB 504. The connector 504a on the PCB 504 is not limited to any type or structure. For example, the connector 504a may include a contact structure (e.g., a C-clip) that contacts the wireless charging coil 510, as shown in FIGS. 6 and 7, or may include an FPCB wherein the connector 504a is engaged with the wireless charging coil 510. According to another embodiment, the connector 504a may correspond to an FPCB connector such as connector 504b shown in FIG. 7, wherein the connector 504a may be integrally configured with the wireless charging coil 510, as shown in FIG. 7.

According to an embodiment, wireless charging technology using the wireless charging coil 510 between the electronic device 500 and the pen input device 600 may use any one of an electromagnetic induction method, a resonance method using resonance, and a radio frequency (RF)/microwave radiation method of converting electric energy into electromagnetic waves for transmission. For example, a power transmission method by electromagnetic induction may be a method of transmitting power by using electromagnetic induction between a first coil (e.g., the wireless charging coil 510) and a second coil (e.g., the coil 610). When an alternating current flows in the first coil (e.g., the wireless charging coil 510) of the electronic device 500, a magnetic field having a direction which changes with time may be generated around the first coil (e.g., the wireless charging coil 510) and induced electromotive force may be generated by the magnetic field in the second coil (e.g., the coil 610), so that power may be transmitted to the pen input device 600. Here, according to an embodiment, the wireless charging coil 510 of the electronic device 500 may be a planar coil included in an FPCB, and the coil 610 of the pen input device 600 may be a winding coil included in a solenoid. In embodiments, both the wireless charging coil 510 and the coil 610 may be winding coils included in solenoids. When the wireless charging coil 510 and the coil 610 are winding coils included in solenoids, the winding coils may have a wound shape around a ferrite core. Because some technology for wireless charging by electromagnetic induction may require a close distance between the first coil and the second coil for transmitting and receiving power, the distance between the electronic device 500 and the pen input device 600 may be relatively small, for example small enough for wireless charging to be effective.

According to an embodiment, an opening 503a may be formed in one side of the second plate 503 of the electronic device 500 to increase wireless charging efficiency between the electronic device 500 and the pen input device 600. For example, the second plate 503 of the electronic device 500 may include metal. The second plate 503 made of metal may interfere with coupling between the wireless charging coil 510 and the coil 610, resulting in reduced efficiency of power transmission. In embodiments, this interference may be prevented by the opening 503a.

According to an embodiment, in order to increase wireless charging efficiency, the wireless charging coil 510 may be on the inner side surface of the housing of the electronic device 500. For example, the wireless charging coil 510 may be in close contact with the inner side surface of the housing of the electronic device 500. According to an embodiment, the wireless charging coil 510 may overlap the opening 503a.

According to an embodiment, as shown in FIG. 6, when the coil 610 of the pen input device 600 and the wireless charging coil 510 of the electronic device 500 are arranged side-by-side at positions corresponding to each other with the second plate 503 therebetween (e.g., a forward attachment state), the magnitude of an induced electromotive force generated in the coil 610 by the magnetic field generated in the wireless charging coil 510 may be the greatest since the wireless charging coil 510 may overlap the coil 610. Accordingly, an optimal efficiency in wireless charging may be exerted.

According to an embodiment, the first magnetic body group 520 may be at least one magnetic body inside the electronic device 500 and may be fixed on the inner side surface of the housing of the electronic device 500. In addition, the first magnetic body group 520 may be aligned, in a first direction, with the wireless charging coil 510 on the inner side surface of the housing. Here, the first direction may denote a +Y direction that is opposite to a −Y direction illustrated in the coordinate axis shown in FIG. 6.

According to an embodiment, the first magnetic body group 520 may include a plurality of magnetic bodies. For example, as shown in FIGS. 6 and 7, the first magnetic body group 520 may include a first-first magnetic body 521 and a first-second magnetic body 522. At least one of the first-first magnetic body 521 and the first-second magnetic body 522 may have a plurality of array polarities. In embodiments, a magnetic body having a single polarity may refer to a magnet which has only one pair of N and S poles. In embodiments, a magnetic body having a plurality of array polarities may refer to a single magnet having polarities which vary depending on the length of the magnet or the position of the magnet, such that the magnet is magnetized with one or more instances of an N pole and an S pole (hereinafter, ‘N-S polarity’) which are arranged to alternate with each other. In embodiments, a magnetic body having a plurality of array polarities may refer to a magnet which is alternatingly magnetized. According to an embodiment, the first-first magnetic body 521 may have a plurality of array polarities including a first portion 521a having a first polarity and a second portion 521b having a second polarity. The first-second magnetic body 522 may have a single polarity.

According to an embodiment, the first-first magnetic body 521 may have more array polarities than the first-second magnetic body 522, and may have a longer shape than the first-second magnetic body 522, so that the first-first magnetic body 521 may have an asymmetric magnetic structure which is different from an asymmetric magnetic structure of the first-second magnetic body 522. In addition, the first-first magnetic body 521 adjacent to the wireless charging coil 510 may have a greater magnetic force than the first-second magnetic body 522 in order to facilitate the attachment and detachment of the pen input device 600 during wireless charging. In addition, at least one of the first-first magnetic body 521 and the first-second magnetic body 522 may include a plurality of magnet sets. For example, the first-first magnetic body 521 may include two magnets and the first-second magnetic body 522 may include a single magnet. Here, the two magnets included in the first-first magnetic body 521 may be adjacent to each other such that polarities are alternatingly magnetized. For example, in embodiments the first portion 521a and the second portion 521b may be separate magnets, and may be arranged as the first-first magnetic body 521 so that the N poles and the S poles alternate along a direction such as the +Y direction and/or the −Y direction.

According to the embodiment, an S polarity may face the wireless charging coil 510 in the first-first magnetic body 521 but embodiments are not limited thereto. An N polarity in the first-second magnetic body 522 may face the first-first magnetic body 521 but embodiments are not limited thereto. In embodiments, both the first-first magnetic body 521 and the first-second magnetic body 522 may be magnets having a plurality of array polarities. For example, the first-first magnetic body 521 may be formed such that the N-S polarity is alternatingly magnetized three or more times and the first-second magnetic body 522 may be formed such that the N-S polarity is alternatingly magnetized two or more times.

According to an embodiment, the first magnetic body group 520 may be provided corresponding to the second magnetic body group 620 provided in the pen input device 600. For example, the number of magnets, polarities of magnets, and/or distances between magnets with respect to the first-first magnetic body 521 and the first-second magnetic body 522 of the first magnetic body group 520 may be determined to correspond to the number of magnets, polarities of magnets, and/or distances between magnets with respect to a second-first magnetic body 621 and a second-second magnetic body 622 included in the second magnetic body group 620 of the pen input device 600. In embodiments corresponding to FIG. 6, the second-first magnetic body 621 included in the second magnetic body group 620 may include a magnet having a plurality of array polarities and the second-second magnetic body 622 may only include a magnet having a single polarity. Correspondingly, the first-first magnetic body 521 included in the first magnetic body group 520 may include a magnet having a plurality of array polarities and the first-second magnetic body 522 may only include a magnet having a single polarity. When the pen input device 600 attaches to the electronic device 500 in a forward direction, a magnet having a plurality of array polarities (e.g., the 521a and the 521b) included in the first-first magnetic body 521 may generate attraction force and repulsion force by corresponding to a plurality of array polarities 621a and 621b included in the second-first magnetic body 621.

According to an embodiment, the first magnetic body group 520 and the second magnetic body group 620 may have an asymmetric magnetic structure in different lengths. In an embodiment where the first magnetic body group 520 includes the first-first magnetic body 521 and the first-second magnetic body 522, and the second magnetic body group 620 includes the corresponding second-first magnetic body 621 and the second-second magnetic body 622, the first-first magnetic body 521 may have a longer length than the first-second magnetic body 522 and the second-first magnetic body 621 may have a longer length than the second-second magnetic body 622. In addition, in an embodiment where the first magnetic body group 520 includes the first-first magnetic body 521 and the first-second magnetic body 522 and the second magnetic body group 620 includes the corresponding second-first magnetic body 621 and the second-second magnetic body 622, the first-first magnetic body 521 and the second-first magnetic body 621 may include a magnet having a plurality of array polarities and the first-second magnetic body 522 and the second-second magnetic body 622 may each only include a magnet having a single polarity. In an embodiment where the first magnetic body group 520 includes the first-first magnetic body 521 and the second magnetic body group 620 includes the second-first magnetic body 621, the second-first magnetic body 621 may have a longer length than the first-first magnetic body 521, the second-first magnetic body 621 may have more array polarities than the first-first magnetic body 521, or the second-first magnetic body 621 may include more magnet sets than the first-first magnetic body 521.

According to an embodiment, the electronic device 500 may include the tilt sensor 530 at a predetermined distance from the first magnetic body group 520. For example, as shown in FIGS. 6 and 7, the tilt sensor 530 may be apart from the first-second magnetic body 522 closest to the tilt sensor 530 by as much as a distance D1. The tilt sensor 530 may be on the PCB 504 or be electrically connected to a sensing circuit on the PCB 504 such that the tilt sensor 530 is fixed on the inner side surface of the housing of the electronic device 500.

According to an embodiment, the tilt sensor 530 may also be aligned with the wireless charging coil 510 and the first magnetic body group 520 in the first direction. Here, the alignment of the tilt sensor 530 with the wireless charging coil 510 and the first magnetic body group 520 in the first direction may refer to the alignment of the wireless charging coil 510, the first magnetic body group 520, and the tilt sensor 530 in a straight line. For example, in embodiments corresponding to FIGS. 6 and 7, the wireless charging coil 510, the first magnetic body group 520, and the tilt sensor 530 may be aligned in the first direction towards the camera module 505. In this case, the tilt sensor 530 may be on the same plane as the wireless charging coil 510 and the first magnetic body group 520, but embodiments are not limited thereto. For example, in an embodiment, the wireless charging coil 510 and the first magnetic body group 520 may be on the inner side surface of the housing and the tilt sensor 530 may be on the PCB 504. Referring to FIGS. 6 and 7, the first-first magnetic body 521 of the first magnetic body group 520 may be adjacent to the wireless charging coil 510 and the first-second magnetic body 522 may be adjacent to the tilt sensor 530. Here, the first-first magnetic body 521 may have more array polarities, more magnet sets (e.g., the embodiment in FIGS. 6 and 7), or longer magnets than the first-second magnetic body 522. In addition to the longer length, the first-first magnetic body 521 may have relatively thicker magnets than the first-second magnetic body 522. As a result, the first-first magnetic body 521 may have relatively greater magnetic force than the first-second magnetic body 522 and the first-second magnetic body 522 may have a relatively weaker magnetic force than the first-first magnetic body 521. Correspondingly, since the second-first magnetic body 621 of the pen input device 600 also has more array polarities, more magnet sets, or longer magnets than the second-second magnetic body 622, the second-first magnetic body 621 may have a relatively greater magnetic force than the second-second magnetic body 622 and the second-second magnetic body 622 may have a relatively weaker magnetic force than the second-first magnetic body 621. The great magnetic force of the first-first magnetic body 521 and the second-first magnetic body 621 may prevent the pen input device 600 from being easily detached from the electronic device 500.

According to an embodiment, the electronic device 500 may perform a wireless charging operation or may not perform a wireless charging operation for the pen input device 600 depending on a direction where the pen input device 600 attaches to the housing. In embodiments, although a direction where the pen input device 600 attaches to the housing is a forward direction, the electronic device 500 may not perform a wireless charging operation when the wireless charging coil 510 of the electronic device 500 does not overlap the coil 610 of the pen input device 600. When the electronic device 500 does not perform the wireless charging operation according to a direction where the pen input device 600 attaches to the housing or according to a state where the wireless charging coil 510 does not overlap the coil 610, the electronic device 500 may determine whether a failure of the wireless charging operation is due to a backward attachment or a tilted attachment and then notify a user of a determined result.

According to an embodiment, the pen input device 600 may be attached to the electronic device 500 by a magnetic force generated between the first-first magnetic body 521 and the second-first magnetic body 621 and by a magnetic force generated between the first-second magnetic body 522 and the second-second magnetic body 622, in a forward attachment state. The electronic device 500 may transmit power to the coil 610 through the wireless charging coil 510. The electronic device 500 may receive a charging signal (or a pen tip signal) B1 by the coil 610 of the pen input device 600 and using the wireless charging coil 510, may wirelessly charge the pen input device 600 according to a specific frequency signal. In the forward attachment state, magnetic flux F1 from the second-first magnetic body 621 and magnetic flux F2 from the second-second magnetic body 622 in the pen input device 600 may not reach the tilt sensor 530.

Referring to FIG. 7, according to an embodiment, the pen input device 600 may attach to the side member 506 of the electronic device 500. In embodiments, an attachment guide region (e.g., the attachment guide region 503′ of FIG. 5) may be on the surface of the side member 506, so that the user may easily recognize the attaching position of the pen input device 600 and attach the pen input device 600 thereon. Accordingly, the electronic device 500 may include the wireless charging coil 510, the first magnetic body group 520, and the tilt sensor 530 on the inner side surface of the side member 506.

According to an embodiment, the wireless charging coil 510, the first magnetic body group 520, and the tilt sensor 530 on the inner surface of the side member 506 may be aligned perpendicular to the PCB 504 in an arrangement that corresponds to the pen input device 600 attaching to the side member 506. According to an embodiment, for electrical connection to the charging circuit 507, the wireless charging coil 510 and the tilt sensor 530 may use a first FPCB 510′ and a second FPCB 530′, respectively, in order to access a connector 504b extending to one side of the PCB 504.

According to an embodiment, the electronic device 500 may include the PCB 504 for arranging electronic components. The electronic components on the PCB 504 may further include a charging circuit 507, a processor 508 (e.g., the processor 120 of FIG. 1), and various other electronic components.

According to an embodiment, the processor 508 may control a wireless charging current for charging the pen input device 600 based on tilt sensing values each sensed by the electronic device 500 and the pen input device 600 that are synchronized with each other, and may selectively display an attachment guide of the pen input device 600. The processor 508 may determine an attachment state of the pen input device 600 to the electronic device 500, based on the wireless charging state of the pen input device 600, the tilt sensing value of the pen input device 600, and the tilt sensing value of the electronic device 500. Based on the attachment state of the pen input device 600, the processor 508 may control a wireless charging current for charging the pen input device 600 and selectively display the attachment guide of the pen input device 600.

According to an embodiment, the electronic device 500 may use tilt sensing values each sensed by the electronic device 500 and the pen input device 600 that are synchronized with each other. The electronic device 500 using the tilt sensing values may determine the attachment state of the pen input device 600 more accurately than the electronic device 500 using magnetic field sensing values. The electronic device 500 may optimize the wireless charging of the pen input device 600 by setting a charging current based on the attachment state of the pen input device 600. For example, when the attachment state of the pen input device 600 corresponds to a fine-tilted attachment state, the electronic device 500 may increase a charging current to reduce the time to completely charge the pen input device 600. In another example, when the attachment state of the pen input device 600 corresponds to an over-tilted attachment state or a reversed attachment state, the electronic device 500 may not charge the pen input device 600 and thus save current which may otherwise be wasted attempting to charge the pen input device 600. In addition, when the attachment state of the pen input device 600 corresponds to an over-tilted attachment state or a reversed attachment state, the electronic device 500 may provide an attachment guide corresponding to each attachment state (e.g., an attachment guide for each angle and a reversed attachment guide) in order to induce the wireless charging of the pen input device 600.

According to an embodiment, in a normal attachment state, the tilt change value of the electronic device 500 may be substantially the same as the tilt change value of the pen input device 600. In a state other than the normal attachment state, the tilt change value of the electronic device 500 may be different from that of the pen input device 600. The electronic device 500 may determine an attachment state of the pen input device 600 using the difference between the tilt sensing value of the electronic device 500 and the tilt sensing value of the pen input device 600. A tilt sensor may include a 3-axis gyro sensor and/or a 3-axis acceleration sensor. The electronic device 500 may determine an attachment state of the pen input device 600 through a tilt sensor (e.g., the tilt sensor 530 of the electronic device and the tilt sensor 631 of the pen input device), thereby removing possible misrecognition caused by an external magnet. The electronic device 500 may use a tilt sensor instead of a magnetic field sensor in order to reduce a current that is consumed to determine an attachment state of the pen input device 600. Hereinafter, the following is a description of determining an attachment state of the pen input device 600 to the electronic device 500 based on a wireless charging state of the pen input device 600, the tilt sensing value of the pen input device 600, and the tilt sensing value of the electronic device 500.

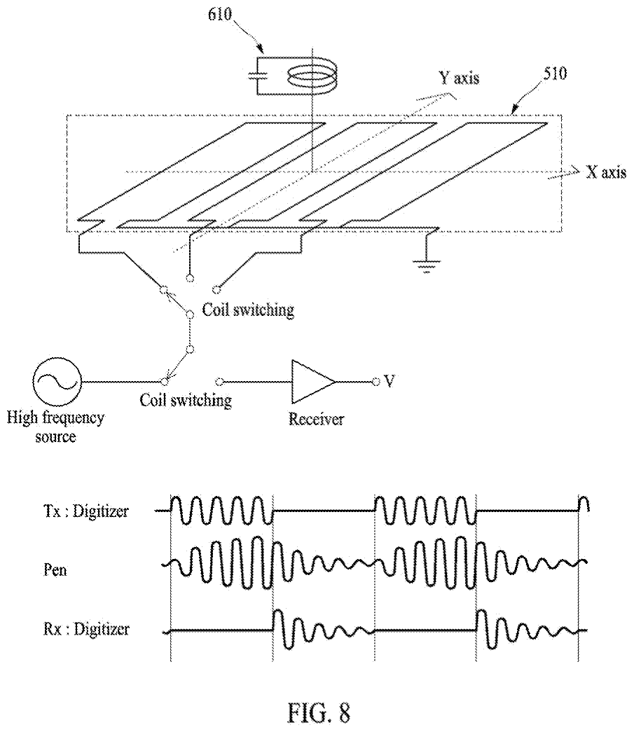

FIG. 8 is a diagram illustrating a wireless charging operation of an electronic device and a pen input device, according to an embodiment;

According to an embodiment, FIG. 8 illustrates examples of a coil 610 for wirelessly charging a pen input device (e.g., the pen input device 600 of FIG. 5) and an electromagnetic induction panel 370 (e.g., a digitizer) of an electronic device (e.g., the electronic device 101 of FIG. 1, the electronic device 200 of FIGS. 2 and 3, the electronic device 300 of FIG. 4, or the electronic device 500 of FIG. 5). Wireless charging between the electronic device 500 and the pen input device 600 may use an EMR method. For example, the pen input device 600 may be operatively interlocked with the electromagnetic induction panel 370 (e.g., a digitizer) by using the coil 610 through an EMR method, an AES method, and an ECR method. The coil 610 may be interlocked with a wireless charging coil (e.g., the wireless charging coil 510 of FIG. 6) included in the electronic device 500. The coil 610 may couple to a wireless charging coil (e.g., the wireless charging coil 510 of FIG. 6) included in the electronic device 500 and thus perform a function of wirelessly charging a battery 630. Resonance with the electromagnetic induction panel 370 and the function of wirelessly charging the battery 630 may be implemented by using the one coil 610 included in the pen input device 600.

According to an embodiment, the wireless charging state of the pen input device 600 may be determined by a ratio between an induced electromotive force that is induced by the current of the electronic device 500 to the pen input device 600 and an induced electromotive force that is induced by the current of the pen input device 600 to the electronic device 500. When a wireless charging operation between the electronic device 500 and the pen input device 600 is detected for the first time, an initial pairing procedure between the electronic device 500 and the pen input device 600 may be performed.

According to an embodiment, during the initial pairing procedure (e.g., a Bluetooth pairing procedure), the tilt sensing time point of the electronic device 500 may synchronize with the tilt sensing time point of the pen input device 600. The initial pairing procedure may determine a calibration value for correcting the difference in tilt sensing values (e.g., the difference between the tilt sensing value of the pen input device 600 and the tilt sensing value of the electronic device 500) in a normal attachment state. At a tilt sensing time point of synchronization between the electronic device 500 and the pen input device 600 or when a designated event occurs (e.g., turning on the display of the electronic device 500 and sensing a motion of the pen input device 600), the electronic device 500 may determine an attachment state of the pen input device 600 using a calibration value. Hereinafter, a description of a calibration operation follows.

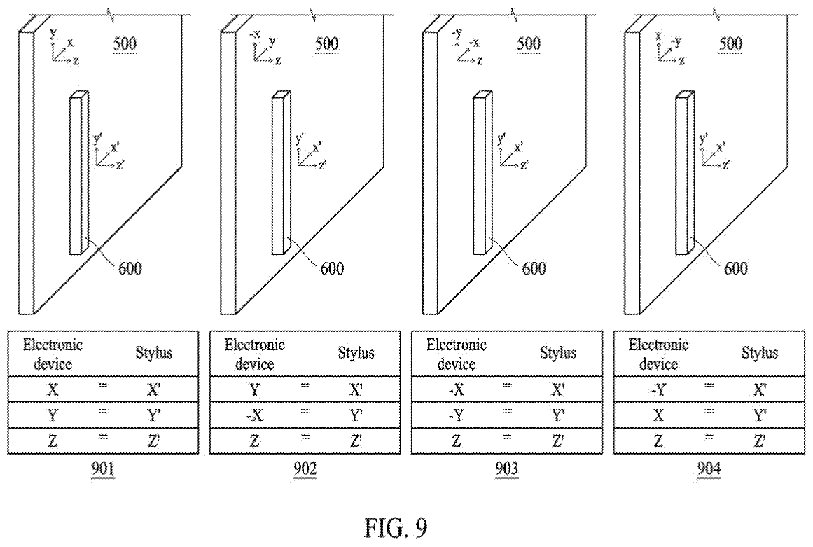

FIG. 9 is a diagram illustrating a calibration operation of an electronic device and a pen input device, according to an embodiment.

FIG. 9 illustrates examples of different orientations of directional axes according to a position of a tilt sensor (e.g., the tilt sensor 530 of FIG. 6) of an electronic device 500 and a tilt sensor (e.g., the tilt sensor 631 of FIG. 6) of a pen input device 600. For example, X direction of first directional axes 901 may correspond to a Y direction of second directional axes 902. For example, a Y direction of the first directional axes 901 may correspond to a −X direction of the second directional axes 902. The tilt sensors 530 and 631 may each include an acceleration sensor and/or a gyro sensor. The acceleration sensor and/or the gyro sensor may be an integrated circuit (IC) chip in a surface mount device (SMD) type. Directional axes of tilt sensors (e.g., an accelerometer and/or a gyro sensor) may not be identical to each other. In order to use the tilt sensors having directional axes not identical to each other, calibration may be performed. In the case of using tilt sensors in which Z axes are the same but X axes and Y axes may not be identical to each other, the number of cases to be considered for the calibration may be 13. In the case of using tilt sensors in which even Z axes may not be the same, the number of cases to be considered for calibration may be 26.

According to an embodiment, upon initial pairing of the electronic device 500 and the pen input device 600, the electronic device 500 may perform calibration of the electronic device 500 and the pen input device 600. When the charging current of the pen input device 600 meets an allowable value (e.g., a normal charging state) and the pen input device 600 enters a Bluetooth pairing routine, the pen input device 600 may transmit, to the electronic device 500, a sensing value sensed by a tilt sensor (e.g., the tilt sensor 631 of FIG. 6). The electronic device 500 may receive the tilt sensing value of the pen input device 600 and determine a calibration value by comparing the tilt sensing value of the electronic device 500 to the tilt sensing value of the pen input device 600. In a normal attachment state, the tilt sensing value of the pen input device 600 may be the same as the tilt sensing value of the electronic device 500. In a normal attachment state, there may be little or no difference between the tilt sensing value of the pen input device 600 and the tilt sensing value of the electronic device 500. The calibration value may be a value for correcting the difference between tilt sensing values (e.g., the difference between the tilt sensing value of the pen input device 600 and the tilt sensing value of the electronic device 500) in a normal attachment state. The calibration value may be redetermined (or updated) whenever the normal attachment state of the pen input device 600 is sensed.

According to an embodiment, the calibration value may be obtained by subtracting the sensed tilt value of the pen input device 600 from the sensed tilt value of the electronic device 500 in a normal attachment state. The calibration value may be calculated through Equation 1.

x_{cal}=x−x′

y_{cal}=y−y′

z_{cal}=z−z′ [Equation 1]

In Equation 1, x, y, and z may denote tilt sensing values of the electronic device 500 and x′, y′, and z′ may denote tilt sensing values of the pen input device 600. In embodiments, the tilt sensing values may be expressed using milli-g (mg), which may indicate 1/1000 of a g, where a g denotes an amount of acceleration induced by Earth's gravity. For example, for the tilt sensing values of the electronic device 500 (x=0 mg, y=0 mg, and z=1000 mg) and the tilt sensing values (x′=0 mg, y′=1000 mg, and z′=0 mg) of the pen input device 600, calibration values (x_cal, y_cal, and z_cal) may be calculated through Equation 2.

x_{cal}=x−x′=0−0=0

y_{cal}=y−y′=0−100=−1000

z_{cal}=z−z′=1000−0=1000 [Equation 2]

According to an embodiment, in the case where an initial pairing procedure is completed such that calibration values and a synchronized sensing time point are determined, the electronic device 500 may determine an attachment state of the pen input device 600 at a sensing time point of a synchronized tilt between the electronic device 500 and the pen input device 600 or when a designated event (e.g., turning on a display of the electronic device 500 or motion sensing of the pen input device 600) occurs.

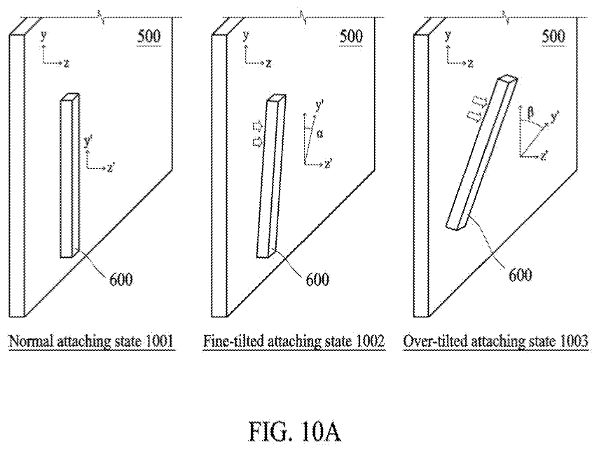

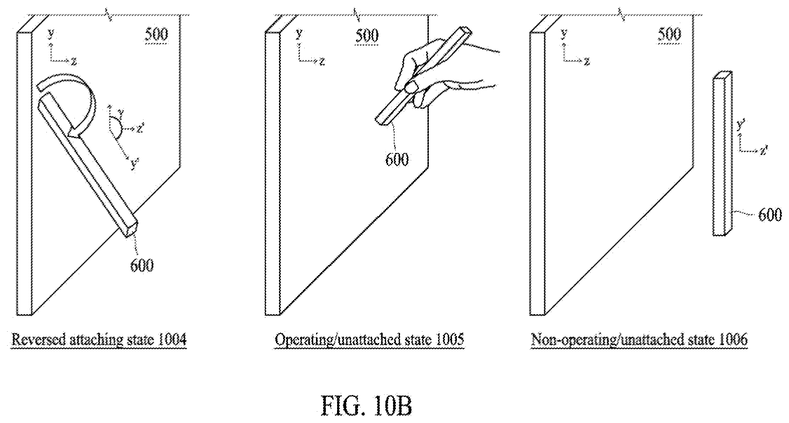

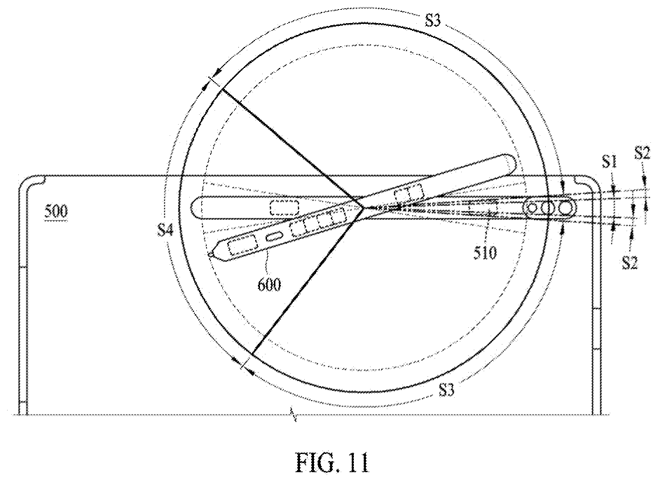

FIGS. 10A and 10B are diagrams illustrating attachment states of a pen input device to an electronic device, and FIG. 11 illustrates examples of relative angles of the pen input device with respect to an electronic device.

According to an embodiment, FIGS. 10A and 10B illustrate examples of attachment states (e.g., a normal attachment state 1001, a fine-tilted attachment state 1002, an over-tilted attachment state 1003, a reversed attachment state 1004, an operating and unattached state 1005, or a non-operating and unattached state 1006) of the pen input device 600. The electronic device 500 may determine an attachment state of a pen input device 600 to an electronic device 500 based on a wireless charging state of the pen input device 600, tilt sensing values of the pen input device 600, and tilt sensing values of the electronic device 500.

Referring to FIGS. 10A, 10B, and 11, according to an embodiment, the normal attachment state 1001 may be the case where a difference value (a difference value considering a calibration value) between the y-axis tilt sensing value of the pen input device 600 and the y-axis tilt sensing value of the electronic device 500 may correspond to a first section 51 (e.g., 359 degrees to 1 degree). The fine-tilted attachment state 1002 may be the case where a difference value ∠α (e.g., a difference value considering a calibration value) between the y-axis tilt sensing value of the pen input device 600 and the y-axis tilt sensing value of the electronic device 500 may correspond to a second section S2 (e.g., about 1 degree to about 3 degrees, and about 357 degrees to about 359 degrees). The over-tilted attachment state 1003 may be the case where a difference value ∠β (e.g., a difference value considering a calibration value) between the y-axis tilt sensing value of the pen input device 600 and the y-axis tilt sensing value of the electronic device 500 may correspond to a third section S3 (e.g., about 3 degrees to about 140 degrees, and about 220 degrees to about 357 degrees). The reversed attachment state 1004 may be the case where a difference value ∠γ (e.g., a difference value considering a calibration value) between the y-axis tilt sensing value of the pen input device 600 and the y-axis tilt sensing value of the electronic device 500 may correspond to a fourth section S4 (e.g., about 140 degrees to about 220 degrees). Hereinafter, a method of converting a difference value between tilt sensing values into an angle is described.

According to an embodiment, a difference value between tilt sensing values calculated by considering calibration values may be expressed through Equation 3.

Δx=(x−x_{cal})−x′

Δy=(y−y_{cal})−y′

Δz=(z−z_{cal})−z′ [Equation 3]

In Equation 3, x, y, and z may denote tilt sensing values of the electronic device 500 in mg, x′, y′, and z′ may denote tilt sensing values of the pen input device 600 in mg, and x_{cal}, y_{cal}, and z_{cal}(mg) may denote calibration values. For example, for tilt sensing values (x=0 mg, y=0 mg, and z=1000 mg) of the electronic device 500, tilt sensing values (x′=0 mg, y′=1000 mg, and z′=0 mg) of the pen input device 600, and calibration values (x_{cal}=0 mg, y_{cal}=−1000 mg, and z_{cal}=1000 mg), difference values Δx, Δy, and Δz of tilt sensing values may be calculated through Equation 4.

Δx=(x−x_{cal})−x′=(0−0)−0=0

Δy=(y−y_{cal})−y′=(0+1000)−1000=0

Δz=(z−z_{cal})−z′=(1000−1000)−0=0 [Equation 4]

According to an embodiment, because there is no difference in the tilt sensing values according to the example of Equation 4, the attachment state of the pen input device 600 may be a normal attachment state. In another embodiment, an example where the difference value Δy of the Y-axis tilt sensing value is 1000 mg may be obtained through Equation 5.

Δx=(x−x_cal)−x′=(0−0)−0=0 mg

Δy=(y−y_cal)−y′=(0−(−1000))−0=1000 mg

Δz=(z−z_cal)−z′=(1000−1000)−0=0 mg

The relative angle of the pen input device 600 with respect to the electronic device 500, which corresponds to the difference values between the sensing values calculated in Equation 5, may be calculated through Equation 6.

$$Δ x ( degree ) = {sin}^{- 1} ( \frac{Δ x}{\sqrt{Δ {x}^{2} + Δ {y}^{2} + Δ {z}^{2}}} ) * \frac{180}{π} = 0 \qquad [ Equation 6 ]$$

$$Δ y ( degree ) = {sin}^{- 1} ( \frac{Δ y}{\sqrt{Δ {x}^{2} + Δ {y}^{2} + Δ {z}^{2}}} ) * \frac{180}{π} = 90$$

$$Δ z ( degree ) = {sin}^{- 1} ( \frac{Δ z}{\sqrt{Δ {x}^{2} + Δ {y}^{2} + Δ {z}^{2}}} ) * \frac{180}{π} = 0$$

According to the value calculated in Equation 6, it may be seen that the relative angle of the pen input device 600 with respect to the electronic device 500 has a value of 90 degrees only in the y-axis. Hereinafter, an operation of determining an attachment state of the pen input device 600 is described in detail with reference to Table 1, in which.

TABLE 1
Event for each tilting angle between electronic device/stylus with respect to acceleration

| | | | | | | | Non- |
|---|---|---|---|---|---|---|---|
| | | | | | | Operating | operating |
| | | Normal | Fine-tilted | Over-tilted | Reversed | and | and |
| | Conditions/ | attachment | attachment | attachment | attachment | unattached | unattached |
| No. | implementation | state | state | state | state | state | state |
| 1 | Charging state | On | On | NG | NG | NG | NG |
| 2 | z′ | Any value | Any value | z′ > ±1 | z′ > ±1 | z′ > ±1 | z′ < ±1 |
| | | | | degree | degree | degree | degree |
| 3 | Δz | N/A | N/A | Δz < ±1 | Δz < ±1 | Δz > ±1 | Don't care |
| | | | | degree | degree | degree | |
| 4 | Δy | 359 to 1 | 1 to 3 | 3 to 140 | 140 to 220 | Any value | Any value |
| | | degree | degrees or | degrees or | degrees | | |
| | | | 357 to 359 | 220 to 357 | (Reversed | | |
| | | | degrees | degrees | angle, γ) | | |
| | | | (Fine-tilted | (Over-tilted | | | |
| | | | angle, α) | angle, β) | | | |
| 5 | Attachment | Forward | Forward | Tilted | Reversed | S-pen in | Standby for |
| | state | attaching | attaching | attaching | attaching | operation | No. 1 or 2 |
| | determination/ | | | | | | event |
| | action | | | | | | |
| 6 | Charging | Rated | Increasing | Charging | Charging | Charging | Charging |
| | current | normal | charging | off | on | off | off |
| | | current | current | | | | |
| 7 | Attachment | Normal | Normal | Attachment | Reversed | N/A | N/A |
| | guide | attachment | attachment | guide for | attachment | | |
| | | guide | guide | each angle | guide | | |

According to an embodiment, the electronic device 500 may check a wireless charging state of the pen input device 600. When the pen input device 600 is being normally charged, the electronic device 500 may determine an attachment state of the pen input device 600 based on a difference value Δy between the Y-axis tilt sensing value of the pen input device 600 and the Y-axis tilt sensing value of the electronic device 500. Based on a calibration value, the electronic device 500 may determine an attachment state of the pen input device 600 to be a normal attachment state when the difference value Δy between the Y-axis tilt sensing value of the pen input device 600 and the y-axis tilt sensing value of the electronic device 500 corresponds to a first section S1 (e.g., about 359 degrees to about 1 degree). Based on a calibration value, the electronic device 500 may determine an attachment state of the pen input device 600 to be a fine-tilted attachment state when the difference value Δy between the Y-axis tilt sensing value of the pen input device 600 and the Y-axis tilt sensing value of the electronic device 500 corresponds to a second section S2 (e.g., about 1 degree to about 3 degrees, or about 357 degrees to about 359 degrees).

According to an embodiment, referring to Table 1, when the pen input device 600 is not normally being charged, the electronic device 500 may determine an attachment state of the pen input device 600 based on a Z-axis tilt sensing value z′ of the pen input device 600. When the Z-axis tilt sensing value z′ of the pen input device 600 is within a threshold value range (e.g., ±1 degree), the electronic device 500 may determine an attachment state of the pen input device 600 to be a non-operating and unattached state. The Z-axis tilt sensing value z′ of the pen input device 600 may be used to determine whether there is movement of the pen input device 600. When the Z-axis tilt sensing value z′ of the pen input device 600 is within the threshold value range, the electronic device 500 may recognize that there is no movement of the pen input device 600 and thus determine an attachment state of the pen input device 600 to be a non-operating and unattached state.

According to an embodiment, referring to Table 1, when the Z-axis tilt sensing value z′ of the pen input device 600 is outside the threshold value range (e.g., ±1 degree), the electronic device 500 may determine an attachment state of the pen input device 600 based on a difference value Δz between the Z-axis tilt sensing value of the pen input device 600 and the Z-axis tilt sensing value of the electronic device 500. When the difference value Δz between the Z-axis tilt sensing value of the pen input device 600 and the Z-axis tilt sensing value of the electronic device 500 is outside the threshold value range (e.g., ±1 degree), the electronic device 500 may determine an attachment state of the pen input device 600 to be an operating and unattached state. The difference value Δz between the Z-axis tilt sensing value of the pen input device 600 and the z-axis tilt sensing value of the electronic device 500 may be to identify the relative movement of the pen input device 600 with respect to the electronic device 500. When the difference Δz between the Z-axis tilt sensing value of the pen input device 600 and the Z-axis tilt sensing value of the electronic device 500 is outside the threshold value range (e.g., ±1 degree), the electronic device 500 may determine that the pen input device 600 operates independently such that the pen input device 600 is not attaching to the electronic device 500. When the difference Δz between the Z-axis tilt sensing value of the pen input device 600 and the Z-axis tilt sensing value of the electronic device 500 is within the threshold value range (e.g., ±1 degree), the electronic device 500 may determine an attachment state of the pen input device 600 based on a difference value Δy between the Y-axis tilt sensing value of the pen input device 600 and the Y-axis tilt sensing value of the electronic device 500.

According to an embodiment, referring to Table 1, the electronic device 500 may determine an attachment state of the pen input device 600 to be an over-tilted attachment state based on a calibration value when the difference value Δy between the Y-axis tilt sensing value of the pen input device 600 and the Y-axis tilt sensing value of the electronic device 500 corresponds to a third section S3 (e.g., 3 degrees to 140 degrees or 220 degrees to 357 degrees). Based on a calibration value, the electronic device 500 may determine an attachment state of the pen input device 600 to be a reversed attachment state when the difference value Δy between the Y-axis tilt sensing value of the pen input device 600 and the Y-axis tilt sensing value of the electronic device 500 corresponds to a fourth section S4 (e.g., 140 degrees to 220 degrees).

According to an embodiment, the electronic device 500 may control a wireless charging current for charging the pen input device 600 based on the attachment state of the pen input device 600 and may selectively display an attachment guide of the pen input device 600. The electronic device 500 may maintain the wireless charging current and display a normal attachment guide in response to the normal attachment state of the pen input device 600. In addition, the electronic device 500 may redetermine (or update) a calibration value for correcting the difference between the tilt sensing value of the pen input device 600 and the tilt sensing value of the electronic device 500 in a normal attachment state. The electronic device 500 may increase a wireless charging current and display a normal attachment guide in response to a fine-tilted attachment state of the pen input device 600. The electronic device 500 may reduce a wireless charging current and display an attachment guide for each angle in response to the over-tilted attachment state of the pen input device 600. The attachment guide for each angle may be to guide, into a normal attachment state, the pen input device 600 that is tilted from the normal attachment state and may include the relative angle of the pen input device 600 with respect to the electronic device 500. The electronic device 500 may reduce a wireless charging current and display a reversed attachment guide in response to the reversed attachment state of the pen input device 600. The reversed attachment guide may include a notification for guiding the pen input device 600 in a direction that is reversed from a normal attachment state to be placed in the normal attachment state.

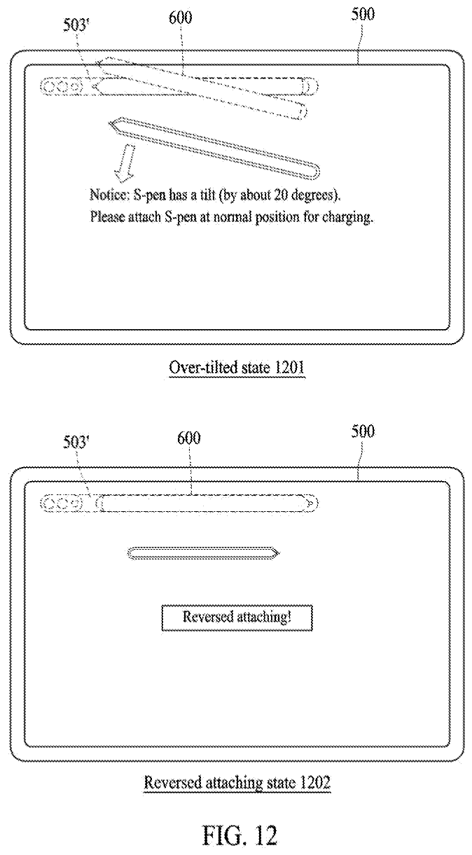

FIG. 12 illustrates an example of an attachment guide of a pen input device, which is displayed on an electronic device, in response to an attachment state of the pen input device.

Referring to FIG. 12, according to an embodiment, an electronic device 500 may display an attachment guide for each angle in response to an over-tilted attachment state 1201 of a pen input device 600. The attachment guide for each angle may include images which correspond to at least one from among the electronic device 500, the pen input device 600, and an attachment guide region 503′. The attachment guide for each angle may include a notification that the pen input device 600 is tilted from a normal attachment state and also include or indicate a relative angle (e.g., about 20 degrees) of the pen input device 600 with respect to the electronic device 500. The electronic device 500 may also display a message indicating a failure of normal charging in response to the over-tilted attachment state of the pen input device 600. The electronic device 500 may display a reversed attachment guide in response to a reversed attachment state 1202 of the pen input device 600. The reversed attachment guide may include an image indicating the reversed attachment state of the pen input device 600 and text indicating the reversed attachment state. In embodiments, the attachment guide may refer to the pen input device 600 by a particular name, for example “S-pen”.

According to an embodiment, an attachment guide (e.g., a normal attachment guide, an attachment guide for each angle, and/or a reversed attachment guide) may include a visual guide and an audio guide that notifies the attachment state of the pen input device 600 and/or the attaching angle of the pen input device 600. The attachment guide may be provided through an external electronic device (e.g., a wearable device or a watch) connecting to the electronic device 500.

According to an embodiment, the electronic device 500 may display a message indicating that the attaching position and/or the attaching direction of the pen input device 600 need to be adjusted, so that a user may intuitively recognize the attachment state of the pen input device 600.

The electronic device according to an embodiment may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be understood that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the items, unless the relevant context clearly indicates otherwise. As used herein, each of the phrases “A or B”, “at least one of A and B”, “at least one of A or B”, “A, B or C”, “at least one of A, B and C”, and “at least one of A, B, or C,” may include any one of the items listed together in the corresponding one of the phrases, and/or all possible combinations thereof. Terms such as “1st,” “2nd,” or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-predetermined integrated circuit (ASIC).

Various embodiments as set forth herein may be implemented as software (e.g., a program) including one or more instructions that are stored in a storage medium (e.g., an internal memory or an external memory) that is readable by a machine. For example, a processor (e.g., a processor) of the machine (e.g., an electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” may mean that the storage medium is a tangible device, and does not include a transitory signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

An electronic device according to an embodiment (e.g., the electronic device 101 of FIG. 1, the electronic device 200 of FIG. 2, the electronic device 300 of FIG. 4, and the electronic device 500 of FIG. 5) may include a communication module (e.g., the communication module 190 of FIG. 1) configured to communicate with a pen input device 600 which is attachable to the electronic device. The electronic device may include a tilt sensor (e.g., the tilt sensors 530 and 530″ of FIG. 7) configured to sense information about a tilt of the electronic device. The electronic device may include at least one processor (e.g., processor 120 of FIG. 1 or processor 508 of FIG. 7) operatively connected to the communication module. The electronic device may include a memory (e.g., the memory 130 of FIG. 1) operatively connected to the at least one processor. When the memory is executed, the at least one processor may be configured to determine an attachment state of the pen input device with respect to the electronic device based on a wireless charging state of the pen input device, a tilt sensing value of the pen input device, and a tilt sensing value of the electronic device. Based on the attachment state, the processor may be configured to control a wireless charging current for charging the pen input device and selectively display an attachment guide of the pen input device.

According to an embodiment, the wireless charging state may be determined based on a ratio between an induced electromotive force, which is induced to the pen input device by a current of the electronic device, and an induced electromotive force, which is induced to the electronic device by a current of the pen input device.

According to an embodiment, the tilt sensor may include at least one of a three-axis gyro sensor (or a gyroscopic sensor) and a three-axis acceleration sensor.

According to an embodiment, the attachment state of the pen input device may include at least one of a normal attachment state, a fine-tilted attachment state, an over-tilted attachment state, a reversed attachment state, an operating and unattached state, and a non-operating and unattached state.

According to an embodiment, when an initial pairing procedure between the electronic device and the pen input device is performed, the at least one processor may be configured to determine a calibration value for correcting a difference between a tilt sensing value of the pen input device and a tilt sensing value of the electronic device in a normal attachment state. The at least one processor may be configured to synchronize a tilt sensing time point of the pen input device with a tilt sensing time point of the electronic device.

According to an embodiment, the calibration value may be obtained by subtracting the tilt sensing value of the pen input device from the tilt sensing value of the electronic device, wherein the tilt sensing values may be sensed in the normal attachment state.

According to an embodiment, at a synchronized tilt sensing time point between the electronic device and the pen input device 600 or when a designated event occurs, the at least one processor may be configured to check the wireless charging state of the pen input device. When the pen input device 600 is normally charged, the at least one processor may be configured to determine an attachment state of the pen input device based on a difference value between a Y-axis tilt sensing value of the pen input device 600 and a Y-axis tilt sensing value of electronic device. When the pen input device 600 is not normally charged, the at least one processor may be configured to determine the attachment state of the pen input device based on a Z-axis tilt sensing value of the pen input device.

According to an embodiment, when the difference value between the Y-axis tilt sensing value of the pen input device and the Y-axis tilt sensing value of the electronic device corresponds to a first section (which may be referred to as a first range), based on the calibration value, the at least one processor may be configured to determine the attachment state of the pen input device to be a normal attachment state. When the difference value between the Y-axis tilt sensing value of the pen input device and the Y-axis tilt sensing value of the electronic device corresponds to a second section (which may be referred to as a second range), based on the calibration value, the at least one processor may be configured to determine the attachment state of the pen input device to be a fine-tilted attachment state.

According to an embodiment, when the Z-axis tilt sensing value of the pen input device 600 is within a threshold value range, the at least one processor may be configured to determine the attachment state of the pen input device to be a non-operating and unattached state. When the Z-axis tilt sensing value of the pen input device 600 is outside the threshold value range, the at least one processor may be configured to determine the attachment state of the pen input device based on a difference value between the Z-axis tilt sensing value of the pen input device and a Z-axis tilt sensing value of the electronic device.

According to an embodiment, processor may be configured to determine the attachment state of the pen input device to be an operating and unattached state, when the difference value between the Z-axis tilt sensing value of the pen input device and the Z-axis tilt sensing value of the electronic device is outside a threshold value range. The at least one processor may be configured to determine the attachment state of the pen input device based on the difference value between the y-axis tilt sensing value of the pen input device and the y-axis tilt sensing value of the electronic device when the difference value between the Z-axis tilt sensing value of the pen input device and the Z-axis tilt sensing value of the electronic device is within the threshold value range

According to an embodiment, based on the calibration value, the at least one processor may be configured to determine the attachment state of the pen input device to be an over-tilted attachment state, when the difference value between the Y-axis tilt sensing value of the pen input device and the Y-axis tilt sensing value of the electronic device corresponds to a third section (which may be referred to as a third range). The at least one processor may be configured to determine the attachment state of the pen input device to be a reversed attachment state, when the difference value between the Y-axis tilt sensing value of the pen input device and the Y-axis tilt sensing value of the electronic device corresponds to a fourth section (which may be referred to as a fourth range).

According to an embodiment, the at least one processor may be configured to update a calibration value for correcting a tilt sensing difference between a tilt sensing value of the pen input device and a tilt sensing value of the electronic device in a normal attachment state when the attachment state of the pen input device corresponds to the normal attachment state.

According to an embodiment, the at least one processor may be configured to maintain a wireless charging current and display a normal attachment guide in response to a normal attachment state.

According to an embodiment, the at least one processor may be configured to increase a wireless charging current and display a normal attachment guide in response to a fine-tilted attachment state.

According to an embodiment, the at least one processor may be configured to reduce a wireless charging current and display an attachment guide for each angle in response to an over-tilted attachment state.

According to an embodiment, the at least one processor may be configured to reduce a wireless charging current and displaying a reversed attachment guide in response to a reversed attachment state.

According to an embodiment, the at least one processor may be configured to reduce a wireless charging current in response to an operating and unattached state and a non-operating and unattached state.

An electronic device (e.g., the electronic device 101 of FIG. 1, the electronic device 200 of FIG. 2, the electronic device 300 of FIG. 4, and the electronic device 500 of FIG. 5) according to an embodiment may include a housing (e.g., the housing 210 of FIGS. 2 and 3) accommodating electronic components in an internal space thereof. The electronic device may include a wireless charging coil (e.g., the wireless charging coil of FIG. 6) positioned inside the housing and configured to charge a pen input device (e.g., the pen input device 600 of FIG. 5) attachable to the electronic device. The electronic device may include a pen attachment magnet (e.g., the first magnetic body group 520 of FIG. 7) aligned in a same direction as the wireless charging coil inside the housing and configured to attach the pen input device to a surface of the electronic device. The electronic device may include a tilt sensor (e.g., the tilt sensors 530 and 530″ of FIG. 7) configured to sense information about a tilt of the electronic device. The electronic device may include a communication module (e.g., the communication module 190 of FIG. 1) configured to receive information about a tilt of the pen input device. The electronic device may include at least one processor (e.g., the processor 120 of FIG. 1 or the processor 508 of FIG. 7) configured to control a wireless charging current for charging the pen input device and selectively display an attachment guide of the pen input device based on tilt sensing values each sensed by the electronic device and the pen input device that are synchronized with each other.

According to an embodiment, the at least one processor may be configured to control the wireless charging current for charging the pen input device and selectively display the attachment guide of the pen input device based on a wireless charging state of the pen input device, a tilt sensing value of the pen input device, and a tilt sensing value of the electronic device.

According to an embodiment, the at least one processor may be configured to determine an attachment state of the pen input device with respect to the electronic device based on the wireless charging state of the pen input device, the tilt sensing value of the pen input device, and the tilt sensing value of the electronic device. Based on the attachment state, the at least one processor may be configured to control the wireless charging current for charging the pen input device and selectively display the attachment guide of the pen input device.

What is claimed is:

1. An electronic device comprising:
a communication module configured to communicate with a pen input device which is attachable to the electronic device;
a tilt sensor configured to sense information about a tilt of the electronic device;
a memory configured to store instructions; and
at least one processor operatively connected to the communication module, and configured to execute the instructions to:
determine an attachment state of the pen input device with respect to the electronic device based on a wireless charging state of the pen input device, a tilt sensing value of the pen input device, and a tilt sensing value of the electronic device; and
based on the attachment state, control a wireless charging current for charging the pen input device, and selectively display an attachment guide of the pen input device.

2. The electronic device of claim 1, wherein the wireless charging state is determined based on a ratio between a first induced electromotive force, which is induced to the pen input device by a current of the electronic device, and a second induced electromotive force, which is induced to the electronic device by a current of the pen input device.

3. The electronic device of claim 1, wherein the tilt sensor comprises at least one of a three-axis gyroscopic sensor and a three-axis acceleration sensor.

4. The electronic device of claim 1, wherein the attachment state of the pen input device comprises at least one of a normal attachment state, a fine-tilted attachment state, an over-tilted attachment state, a reversed attachment state, an operating and unattached state, and a non-operating and unattached state.

5. The electronic device of claim 1, wherein the at least one processor is further configured to, based on an initial pairing procedure between the electronic device and the pen input device being performed:
determine a calibration value for correcting a difference between a tilt sensing value of the pen input device and a tilt sensing value of the electronic device in a normal attachment state; and
synchronize a tilt sensing time point of the pen input device with a tilt sensing time point of the electronic device.

6. The electronic device of claim 5, wherein the calibration value is obtained by subtracting the tilt sensing value of the pen input device from the tilt sensing value of the electronic device, and
wherein the tilt sensing value of the pen input device and the tilt sensing value of the electronic device are sensed in the normal attachment state.

7. The electronic device of claim 5, wherein the at least one processor is further configured to, at a synchronized tilt sensing time point between the electronic device and the pen input device, or based on a designated event occurring:
determine the wireless charging state of the pen input device;
based on the pen input device being in a normal charging state, determine the attachment state of the pen input device based on a difference value between a Y-axis tilt sensing value of the pen input device and a Y-axis tilt sensing value of electronic device; and
based on the pen input device being not in the normal charging state, determine the attachment state of the pen input device based on a Z-axis tilt sensing value of the pen input device.

8. The electronic device of claim 7, wherein the at least one processor is further configured to, based on the calibration value:
based on the difference value between the Y-axis tilt sensing value of the pen input device and the Y-axis tilt sensing value of the electronic device corresponding to a first range, determine the attachment state of the pen input device to be the normal attachment state; and
based on the difference value between the y-axis tilt sensing value of the pen input device and the y-axis tilt sensing value of the electronic device corresponding to a second range, determine the attachment state of the pen input device to be a fine-tilted attachment state.

9. The electronic device of claim 7, wherein the at least one processor is further configured to:
based on the Z-axis tilt sensing value of the pen input device being within a threshold value range, determine the attachment state of the pen input device to be a non-operating and unattached state; and
based on the Z-axis tilt sensing value of the pen input device being outside of the threshold value range, determine the attachment state of the pen input device based on a difference value between the Z-axis tilt sensing value of the pen input device and a Z-axis tilt sensing value of the electronic device.

10. The electronic device of claim 9, wherein the at least one processor is further configured to:
determine the attachment state of the pen input device to be an operating and unattached state, based on the difference value between the Z-axis tilt sensing value of the pen input device and the Z-axis tilt sensing value of the electronic device is outside of the threshold value range; and
determine the attachment state of the pen input device based on the difference value between the Y-axis tilt sensing value of the pen input device and the Y-axis tilt sensing value of the electronic device when the difference value between the Z-axis tilt sensing value of the pen input device and the Z-axis tilt sensing value of the electronic device is within the threshold value range.

11. The electronic device of claim 10, wherein, based on the calibration value, the processor is configured to:
determine the attachment state of the pen input device to be an over-tilted attachment state, being the difference value between the Y-axis tilt sensing value of the pen input device and the Y-axis tilt sensing value of the electronic device corresponding to a third range; and
determine the attachment state of the pen input device to be a reversed attachment state, based on the difference value between the Y-axis tilt sensing value of the pen input device and the Y-axis tilt sensing value of the electronic device corresponds to a fourth range.

12. The electronic device of claim 1, wherein the at least one processor is further configured to, based on determining that the attachment state corresponds to a normal attachment state, update a calibration value for correcting a tilt sensing difference between a tilt sensing value of the pen input device and a tilt sensing value of the electronic device in the normal attachment state.

13. The electronic device of claim 1, wherein the at least one processor is further configured to, based on determining that the attachment state corresponds to a normal attachment state, maintain the wireless charging current, and to display a normal attachment guide based on determining that the attachment state of the pen input device corresponds to the normal attachment state.

14. The electronic device of claim 1, wherein the at least one processor is further configured to, based on determining that the attachment state corresponds to a fine-tilted attachment state, increase the wireless charging current, and to display a normal attachment guide.

15. The electronic device of claim 1, wherein the at least one processor is further configured to, based on determining that the attachment state corresponds to an over-tilted attachment state, reduce the wireless charging current, and to display the attachment guide for each angle.

16. The electronic device of claim 1, wherein the at least one processor is further configured to, based on determining that the attachment state corresponds to a reversed attachment state, reduce the wireless charging current, and to display a reversed attachment guide.

17. The electronic device of claim 1, wherein the at least one processor is further configured to, based on determining that the attachment state corresponds to at least one of an operating and unattached state and a non-operating and unattached state, reduce the wireless charging current.

18. An electronic device comprising:
a housing having an internal space configured to accommodate one or more electronic components;
a wireless charging coil positioned inside the housing, and configured to charge a pen input device which is attachable to the electronic device;
a pen attachment magnet aligned in a same direction as the wireless charging coil inside the housing, and configured to cause the pen input device to attach to a surface of the electronic device;
a tilt sensor configured to sense information about a tilt of the electronic device;
a communication module configured to receive information about a tilt of the pen input device; and
at least one processor configured to control a wireless charging current for charging the pen input device and selectively display an attachment guide of the pen input device, based on first tilt sensing values sensed by the electronic device and second tilt sensing values sensed by the pen input device based on the electronic device being synchronized with the pen input device.

19. The electronic device of claim 18, wherein the at least one processor is further configured to control the wireless charging current and selectively display the attachment guide based on a wireless charging state of the pen input device, a second tilt sensing value of the pen input device, and a first tilt sensing value of the electronic device.

20. The electronic device of claim 18, wherein the at least one processor is further configured to:
determine an attachment state of the pen input device with respect to the electronic device based on a wireless charging state of the pen input device, a tilt sensing value of the pen input device, and a tilt sensing value of the electronic device; and
based on the attachment state, control the wireless charging current and selectively display the attachment guide.
